(19) United States
(12) Patent Application Publication
(10) Pub. No.: US 2018/0367461 A1
(43) Pub. Date: Dec. 20, 2018

(54) IDENTIFICATION METHOD AND DEVICE BASED ON COMMUNICATION FLOWS OF DIFFERENT FUNCTIONS OF SKYPE

(71) Applicants: NSFOCUS INFORMATION TECHNOLOGY CO., LTD, Haidian District, Beijing (CN); NSFOCUS TECHNOLOGIES,INC., Haidian District, Beijing (CN)

(72) Inventor: Muchi XU, Haidian District, Beijing (CN)

(21) Appl. No.: 16/060,002

(22) PCT Filed: Dec. 2, 2016
(86) PCT No.: PCT/CN2016/108441

§ 371 Date: Jun. 6, 2018

(30) Foreign Application Priority Data
Dec. 18, 2015 (CN) 201510958932.1

(51) Int. Cl. H04L 12/851; H04L 29/06; H04L 12/26; H04L 12/24; H04L 29/08; H04L 12/859

(52) U.S. Cl. CPC H04L 47/2483; H04L 63/0245; H04L 47/2475; H04L 41/0896; H04L 67/146; H04L 43/028

(57) ABSTRACT

Disclosed are an identification method and device based on communication flows of different functions of Skype. The method comprises: acquiring a transmission message in a current session and initially detecting the transmission message; if the transmission message is accurately identified, marking, to the current session, a corresponding function application label; otherwise, determining a detection level to which the transmission message belongs; detecting the transmission message according to a detection rule corresponding to the detection level to which the transmission message belongs; and when a detection condition is satisfied, marking, to the current session, a function application label corresponding to the detection level to which the transmission message belongs. That is to say, in the present invention, by means of incremental identification, the problem that the coupling flow cannot be distinguished is solved, so that a single function of Skype can be identified, and the fine access control to a flow of Skype can be completed.

### CROSS-REFERENCE TO RELATED APPLICATIONS

This application claims the benefit of Chinese Patent Application No. CN201510958932.1, filed with the Chinese Patent Office on Dec. 18, 2015 and entitled “A recognition method and apparatus based on communication streams of different functions of Skype”, the content of which is hereby incorporated by reference in its entirety.

### FIELD

The present invention relates to the field of communication technologies, and particularly to a recognition method and apparatus based on communication streams of different functions of Skype.

### BACKGROUND

Skype is one of the most popular instant communication software of the world. It enables free and clear voice conversations between different users and supports domestic or international calls. Skype mainly uses peer to peer (P2P) network architectures and private protocols to communicate and encrypts data strongly. In addition, communication processes of Skype are very complicated and involve with a large amount of codes. Therefore, it is difficult to work backwards to analyze source codes of Skype and so far only simple recognition of Skype has been able to be performed.

For example, existing recognition technologies could recognize a login process of Skype to restrict use of all functions of Skype, or could recognize a part of traffic of a Skype function, e.g., recognize a part of traffic corresponding to communication streams generated by certain functions of Skype and restrict the part of traffic if the part of traffic exceeds a traffic threshold. However, the existing recognition technologies cannot fully recognize a single function of Skype such as text chat or file transfer, etc., because during communication processes, a part of traffic of some main functions of Skype are coupled such that it is hard for the existing recognition technologies to recognize, thus making it unable to restrict traffic of the single function of Skype.

In other words, the existing recognition technologies cannot recognize traffic with strong coupling of the communication streams of Skype functions, therefore cannot recognize the single function of Skype, and thus cannot precisely restrict traffic of common functions of Skype.

### SUMMARY

Embodiments of the present invention provides a recognition method and apparatus based on communication streams of different functions of Skype, to solve the problem that traffic with strong coupling of the communication streams of Skype functions cannot be recognized and thus the single function of Skype cannot be recognized, therefore traffic of common functions of Skype cannot be precisely restricted.

In a first aspect, an embodiment of the invention provides a recognition method based on communication streams of different functions of Skype, the method includes: obtaining a transmission message in a current session; performing a preliminary detection of the transmission message, and marking the current session with a corresponding application label of function if the transmission message is accurately recognized, or determining a detecting level of the transmission message if the transmission message is not accurately recognized; detecting the transmission message according to a detecting rule corresponding to the detecting level of the transmission message and marking the current session with an application label of function corresponding to the detecting level of the transmission message when a detecting condition is satisfied.

Combined with the first aspect, in a first possible implementation of the first aspect, the method further includes: restricting traffic of the current session marked with a corresponding application label of function.

Combined with the first aspect, in a second possible implementation of the first aspect, performing the preliminary detection of the transmission message includes: performing the preliminary detection of the transmission message by using Deep Packet Inspection (DPI) technology and Deep/Dynamic Flow Inspection (DFI) technology.

Combined with the first aspect, in a third possible implementation of the first aspect, determining the detecting level of the transmission message includes: determining a value P corresponding to a position of the obtained transmission message in the current session, wherein P is a positive integer; and determining the detecting level of the transmission message according to the value P corresponding to the position of the transmission message in the current session and predefined detecting levels.

Combined with the third possible implementation of the first aspect, in a fourth possible implementation of the first aspect, the detecting levels at least includes a suspected Skype session detecting level, a text transmission detecting level, a file transmission detecting level and a voice and video detecting level; wherein a range of values corresponding to a position of a transmission message of the suspected Skype session detecting level in the current session is 0-P1, a range of values corresponding to a position of a transmission message of the text transmission detecting level in the current session is P1-P2, a range of values corresponding to a position of a transmission message of the file transmission detecting level in the current session is P3-P4, and a range of values corresponding to a position of a transmission message of the voice and video transmission detecting level in the current session is P5-P6; wherein 0<P1<P2, P2<P3<P4 and P2<P5<P6.

Combined with the fourth possible implementation of the first aspect, in a fifth possible implementation of the first aspect, upon determining that the detecting level of the transmission message is the suspected Skype session detecting level and the current session is not marked with a corresponding application label of function, detecting the transmission message according to the detecting rule corresponding to the detecting level of the transmission message includes: detecting Skype characteristics of the transmission message.

Combined with the fifth possible implementation of the first aspect, in a sixth possible implementation of the first aspect, the Skype characteristics at least includes: a session port, a message length, a flow direction of a message at a specific position, or a load of an application layer.

Combined with the fourth possible implementation of the first aspect, in a seventh possible implementation of the first aspect, upon determining that the detecting level of the transmission message is the text transmission level and the current session is marked with an application label of suspected Skype session, detecting the transmission message according to the detecting rule corresponding to the detecting level of the transmission message includes: detecting traffic and Skype text transmission characteristics of the transmission message.

Combined with the fourth possible implementation of the first aspect, in an eighth possible implementation of the first aspect, upon determining that the detecting level of the transmission message is the file transmission detecting level and the current session is marked with an application label of text transmission function, detecting the transmission message according to the detecting rule corresponding to the detecting level of the transmission message includes: detecting traffic and Skype file transmission characteristics of the transmission message.

Combined with the fourth possible implementation of the first aspect, in a ninth possible implementation of the first aspect, upon determining that the detecting level of the transmission message is the voice and video detecting level and the current session is marked with an application label of text transmission function, detecting the transmission message according to the detecting rule corresponding to the detecting level of the transmission message includes: detecting traffic and Skype voice and video characteristics of the transmission message.

In a second aspect, an embodiment of the invention provides a recognition apparatus based on communication streams of different functions of Skype, the apparatus includes: an obtaining unit configured to obtain a transmission message in a current session; and a processing unit configured to perform a preliminary detection of the transmission message obtained by the obtaining unit; and mark the current session with a corresponding application label of function if the transmission message is accurately recognized; or determine a detecting level of the transmission message if the transmission message is not accurately recognized, and detect the transmission message according to a detecting rule corresponding to the detecting level of the transmission message and mark the current session with an application label of function corresponding to the detecting level of the transmission message when a detecting condition is satisfied.

Combined with the second aspect, in a first possible implementation of the second aspect, the apparatus further includes: a traffic restricting unit configured to restrict traffic of the current session marked with a corresponding application label of function.

Combined with the second aspect, in a second possible implementation of the second aspect, the processing unit is particularly configured to perform the preliminary detection of the transmission message by using a DPI technology and a DFI technology.

Combined with the second aspect, in a third possible implementation of the second aspect, the processing unit is particularly configured to: determine a value P corresponding to a position of the obtained transmission message in the current session, wherein P is a positive integer; and determine the detecting level of the transmission message according to the value P corresponding to the position of the transmission message in the current session and predefined detecting levels.

Combined with the third possible implementation of the second aspect, in a fourth possible implementation of the second aspect, the detecting levels at least includes a suspected Skype session detecting level, a text transmission detecting level, a file transmission detecting level and a voice and video detecting level; wherein a range of values corresponding to a position of a transmission message of the suspected Skype session detecting level in the current session is 0-P1, a range of values corresponding to a position of a transmission message of the text transmission detecting level in the current session is P1-P2, a range of values corresponding to a position of a transmission message of the file transmission detecting level in the current session is P3-P4, and a range of values corresponding to a position of a transmission message of the voice and video transmission detecting level in the current session is P5-P6; wherein 0<P1<P2, P2<P3<P4 and P2<P5<P6.

Combined with the fourth possible implementation of the second aspect, in a fifth possible implementation of the second aspect, the processing unit is particularly configured to detect Skype characteristics of the transmission message upon determining that the detecting level of the transmission message is the suspected Skype session detecting level and the current session is not marked with a corresponding application label of function.

Combined with the fourth possible implementation of the second aspect, in a six possible implementation of the second aspect, the Skype characteristics at least includes: a session port, a message length, a flow direction of a message at a specific position, or a load of an application layer.

Combined with the fourth possible implementation of the second aspect, in a seventh possible implementation of the second aspect, the processing unit is particularly configured to detect traffic and Skype text transmission characteristics of the transmission message upon determining that the detecting level of the transmission message is the text transmission level and the current session is marked with an application label of suspected Skype session.

Combined with the fourth possible implementation of the first aspect, in an eighth possible implementation of the first aspect, the processing unit is particularly configured to detect traffic and Skype file transmission characteristics of the transmission message upon determining that the detecting level of the transmission message is the file transmission detecting level and the current session corresponding to the transmission message is marked with an application label of text transmission function.

Combined with the fourth possible implementation of the first aspect, in a ninth possible implementation of the first aspect, the processing unit is particularly configured to detect traffic and Skype voice and video characteristics of the transmission message upon determining that the detecting level of the transmission message is the voice and video detecting level and the current session is marked with an application label of text transmission function.

In the method and apparatus according to the first and the second aspects, a transmission message in a current session is obtained and preliminarily detected. If the transmission message is accurately recognized, then the current session is marked with a corresponding application label of function. Otherwise a detecting level of the transmission message is determined and the transmission message is detected according to a detecting rule corresponding to the detecting level of the transmission message and the current session is marked with an application label of function corresponding to the detecting level of the transmission message if a detecting condition is satisfied. In other words, in the technical solution according to the embodiment of the invention, the problem of inability to distinguish between coupled traffic is solved through incremental recognition, so that a single function of

Skype can be recognized and a precise access control of the traffic of Skype can be achieved, thus a specified function of Skype can be blocked and network bandwidth and a work environment can be improved.

### BRIEF DESCRIPTION OF THE DRAWINGS

To make technical solutions of embodiments of the invention clearer, drawings to be used in descriptions of the embodiments are briefly introduced below. Obviously, the drawings mentioned below just illustrate some but not all embodiments of the invention and those skilled in the art could obtain other drawings based on the drawings without any inventive efforts.

FIG. 1 is a schematic flow chart of a recognition method based on communication streams of different functions of Skype according to a first embodiment of the invention.

FIG. 2 is a detailed schematic flow chart of the recognition method based on communication streams of different functions of Skype according to the first embodiment of the invention.

FIG. 3 is a structural schematic diagram of a recognition apparatus based on communication streams of different functions of Skype according to a second embodiment of the invention.

### DETAILED DESCRIPTION OF THE EMBODIMENTS

To make the purpose, technical solutions, and advantages of the embodiments of the invention clearer, the invention is described below in details with reference to the drawings. Apparently the embodiments described below are only a part but not all of the embodiments of the invention. Based upon the embodiments disclosed herein, all the other embodiments which can occur to those skilled in the art without any inventive effort shall fall into the scope of the invention.

A first embodiment

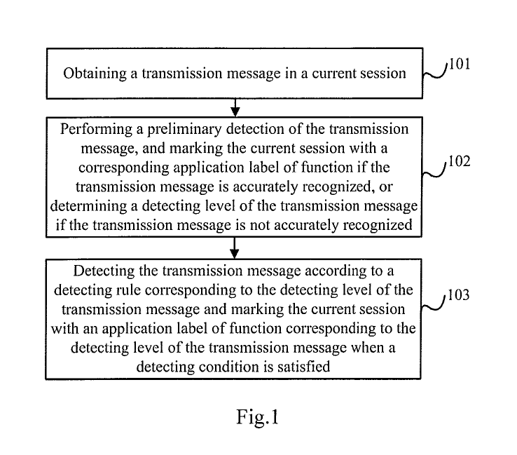

The first embodiment of the invention provides a recognition method based on communication streams of different functions of Skype. As illustrated by FIG. 1, which is a schematic flow chart of the method, the method includes the following operations.

Operation 101 is obtaining a transmission message in a current session.

Operation 102 is performing a preliminary detection of the transmission message, and marking the current session with a corresponding application label of function if the transmission message is accurately recognized, or determining a detecting level of the transmission message if the transmission message is not accurately recognized.

Operation 103 is detecting the transmission message according to a detecting rule corresponding to the detecting level of the transmission message and marking the current session with an application label of function corresponding to the detecting level of the transmission message when a detecting condition is satisfied.

In other words, in the technical solution according to the embodiment of the invention, the problem of inability to distinguish between coupled traffic is solved by incremental recognition, so that a single function of Skype can be recognized and a precise access control of the traffic of Skype can be achieved, thus a specified function of Skype can be blocked and network bandwidth and a work environment can be improved.

Moreover, performing the preliminary detection of the transmission message in operation 102 can be particularly implemented by: performing the preliminary detection of the transmission message by using a DPI technology and a DFI technology.

It should be noted that by combining the DPI technology and the DFI technology, uncoupled traffic of Skype can be accurately recognized and thus the accurately recognized session can be marked with a corresponding application label of function, and there is no succeeding detecting operation of the session, which means the detection of the session corresponding to the uncoupled Skype traffic can be completed in this operation.

Moreover, determining the detecting level of the transmission message in the operation 102 can be particularly implemented by: determining a value P corresponding to a position of the obtained transmission message in the current session and determining the detecting level of the transmission message according to the value P corresponding to the position of the transmission message in the current session and predefined detecting levels, wherein P is a positive integer.

Optionally, the detecting levels at least includes a suspected Skype session detecting level, a text transmission detecting level, a file transmission detecting level and a voice and video detecting level. Wherein a range of values corresponding to a position of a transmission message of the suspected Skype session detecting level in the current session is 0-P1, a range of values corresponding to a position of a transmission message of the text transmission detecting level in the current session is P1-P2, a range of values corresponding to a position of a transmission message of the file transmission detecting level in the current session is P3-P4, and a range of values corresponding to a position of a transmission message of the voice and video transmission detecting level in the current session is P5-P6; wherein 0<P1<P2, P2<P3<P4 and P2<P5<P6.

It should be noted that predefining a detecting level of Skype according to a range of values corresponding to a position of a transmission message in the current session can be implemented through analysis of traffic characteristics of the transmission message and comprehensive processing of empirical values. And after having defined the detecting levels of Skype, a statistical threshold corresponding to traffic in each detecting level can be determined, i.e., a preset statistical traffic threshold corresponding to the suspected Skype session detecting level, a first preset statistical traffic threshold corresponding to the text transmission detecting level, a second preset statistical traffic threshold corresponding to the file transmission detecting level and a third preset statistical traffic threshold corresponding to the voice and video transmission detecting level. Moreover, it should be noted that generally traffic is not counted during suspected Skype session detecting, therefore the preset traffic statistical threshold corresponding to the suspected Skype session detecting level is usually zero, and the other preset traffic statistical thresholds are obtained through the analysis of traffic characteristics and comprehensive processing of empirical values, which is not repeated herein.

Moreover, in operation 103, when determining that the detecting level of the transmission message is the suspected Skype session detecting level and the current session is not marked with a corresponding application label of function, detecting the transmission message according to the detecting rule corresponding to the detecting level of the transmission message can be particularly implemented by detecting Skype characteristics of the transmission message.

In other words, after detecting the Skype characteristics of the transmission message, if the transmission message has the Skype characteristics, the current session corresponding to the transmission message is marked with an application label of suspected Skype session.

It should be noted that, if the detecting level of the transmission message is the suspected Skype session detecting level, but the current session corresponding to the transmission message is marked with a corresponding application label of function, then the detecting process is ended to maintain the detecting result of the current session by the DPI technology and DFI technology in the preliminary detection.

Optionally, the Skype characteristics may include at least a session port, a message length, a flow direction of a message at a specific position, or a load of an application layer, which are not described in further details herein.

Particularly, detecting Skype characteristics of the transmission message may include detecting whether a session port number occupied by the current session corresponding to the transmission message is a corresponding session port configured by Skype, or detecting whether a start position of a message corresponding to a Skype transmission protocol signature match a corresponding start position configured by Skype. When the transmission message has one or more Skype characteristics, the current session corresponding to the transmission message can be marked with the application label of suspected Skype session.

Moreover, in operation 103, when determining that the detecting level of the transmission message is the text transmission level and the current session is marked with the application label of suspected Skype session, detecting the transmission message according to the detecting rule corresponding to the detecting level of the transmission message can be particularly implemented by detecting traffic and Skype text transmission characteristics of the transmission message.

Particularly, detecting traffic and Skype text transmission characteristics of the transmission message can be particularly implemented by: counting traffic of a first part of the transmission message having Skype text transmission characteristics and determining the traffic statistical value of the first part of the transmission message; extracting the Skype text transmission characteristics from the first part of the transmission message and detecting the Skype text transmission characteristics; comparing the traffic statistical value of the first part of the transmission message with the first preset statistical traffic threshold of the text transmission detecting level and determining whether the Skype text transmission characteristics of the first part of the transmission message match Skype text transmission characteristics corresponding to the text transmission detecting level.

After that, if the traffic statistical value of the first part of the transmission message is not less than the first preset statistical traffic threshold and the Skype text transmission characteristics of the first part of the transmission message match the Skype text transmission characteristics corresponding to the text transmission detecting level, the current session corresponding to the transmission message is marked with an application label of text transmission function.

It should be noted that, if the detecting level of the transmission message is the text transmission detecting level, but the current session corresponding to the transmission message is not marked with the application label of suspected Skype session, then the detecting process is ended to maintain the detecting result of the suspected Skype session level.

It also needs to be noted that, to make the detection of the text transmission detecting level faster, as an alternative to detect traffic and Skype text transmission characteristics simultaneously at the level, the detection at the level can also be implemented by detecting only the traffic of the transmission message. That is, if the traffic statistical value of the first part of the transmission message is ascertained to be not less than the first preset statistical traffic threshold, the current session corresponding to the transmission message can be directly marked with the application label of text transmission function, which is not described in further details herein.

Moreover, in operation 103, when determining that the detecting level of the transmission message is the file transmission detecting level and the current session corresponding to the transmission message is marked with the application label of text transmission function, detecting the transmission message according to the detecting rule corresponding to the detecting level of the transmission message can be particularly implemented by detecting the traffic and Skype file transmission characteristics of the transmission message.

Particularly, detecting the traffic and Skype file transmission characteristics of the transmission message can be particularly implemented by: counting traffic of a second part of the transmission message having Skype file transmission characteristics and determining a traffic statistical value of the second part of the transmission message; extracting the Skype file transmission characteristics from the second part of the transmission message and detecting the

Skype file transmission characteristics; comparing the traffic statistical value of the second part of the transmission message with the second preset statistical traffic threshold of the file transmission detecting level and determining whether the Skype file transmission characteristics of the second part of the transmission message match Skype file transmission characteristics corresponding to the file transmission detecting level.

After that, if the traffic statistical value of the second part of the transmission message is not less than the second preset statistical traffic threshold and the Skype file transmission characteristics of the second part of the transmission message match the Skype file transmission characteristics corresponding to the file transmission detecting level, the current session corresponding to the transmission message is marked with an application label of file transmission function.

If the traffic statistical value of the second part of the transmission message is less than the second preset statistical traffic threshold and/or the Skype file transmission characteristics of the second part of the transmission message do not match the Skype file transmission characteristics corresponding to the file transmission detecting level, and the detecting level of the transmission message is ascertained to be the voice and video detecting level, the Skype voice and video characteristics of the second part are extracted and correspondingly detected. When the Skype voice and video characteristics of the second part of the transmission message match the Skype voice and video characteristics of the voice and video detecting level, the current session corresponding to the transmission message is marked with an application label of a voice and video function.

In other words, when the current session corresponding to the transmission message is ascertained to be a session of file transmission function, the application label of function of the current session corresponding to the transmission message can be updated, which means the application label of text transmission function of the current session corresponding to the transmission message marked at the upper text transmission detecting level is updated to be the application label of file transmission function. If the detecting condition of the file transmission file detecting level is not satisfied, e.g., the traffic statistical value of the second part of the transmission message is less than the second preset statistical traffic threshold, then it is determined whether the detecting level of the transmission message is the voice and video detecting level or not. If it is, the voice and video characteristics of the transmission message are detected, and if the detecting condition of the voice and video detecting level is met, the application label of function of the current session corresponding to the transmission message is updated, i.e., the application label of text transmission function of the current session corresponding to the transmission message marked at the upper text transmission detecting level is updated to be the application label of the voice and video function.

It should be noted that a current detecting process is ended if none of detecting conditions of a detecting level is satisfied. E.g., if the detecting level of the transmission message is ascertained to be the file transmission detecting level but the current session corresponding to the transmission message is not marked with the application label of text transmission function, then the detecting process is ended and the detecting result of the text transmission detecting layer is maintained.

It also needs to be noted that, to make the detection of the file transmission detecting level faster, as an alternative to detect the traffic and Skype file transmission characteristics simultaneously at the level, the detection at the level can also be implemented by detecting only the traffic of the transmission message. That is, if the traffic statistical value of the second part of the transmission message is ascertained to be not less than the second preset statistical traffic threshold, the current session corresponding to the transmission message can be directly marked with the application label of file transmission function.

If the traffic statistical value of the second part of the transmission message is less than the second preset statistical traffic threshold and the detecting level of the transmission message is ascertained to be the voice and video detecting level, then the Skype voice and video characteristics of the second part of the transmission message are extracted and detected, when the Skype voice and video characteristics of the second part of the transmission message match the Skype voice and video characteristics corresponding to the voice and video detecting level, the current session corresponding to the transmission message is marked with the application label of voice and video function.

Moreover, in operation 103, when determining that the detecting level of the transmission message is the voice and video detecting level and the current session is marked with the application label of text transmission function, detecting the transmission message according to the detecting rule corresponding to the detecting level of the transmission message could be particularly implemented by detecting the traffic and Skype voice and video characteristics of the transmission message.

Particularly, detecting the traffic and Skype voice and video characteristics of the transmission message can be implemented by: counting traffic of a third part of the transmission message having Skype voice and video characteristics and determining the traffic statistical value of the third part of the transmission message; extracting the Skype voice and video characteristics from the third part of the transmission message and detecting the Skype voice and video characteristics; comparing the traffic statistical value of the third part of the transmission message with the third preset statistical traffic threshold of the voice and video detecting level and determining whether the Skype voice and video characteristics of the third part of the transmission message match Skype voice and video characteristics corresponding to the voice and video detecting level.

Then if the traffic statistical value of the third part of the transmission message is not less than the third preset statistical traffic threshold and the Skype voice and video characteristics of the third part of the transmission message match the Skype voice and video characteristics corresponding to the voice and video detecting level, the current session corresponding to the transmission message is marked with the application label of voice and video function.

That is, if the current session corresponding to the transmission message is a session of voice and video function, the application of label of the current session corresponding to the transmission message is updated, i.e., the application label of the text transmission function of the current session corresponding to the transmission message marked at the upper text transmission detecting level is updated to be the application label of voice and video function.

It should be noted that, if the detecting level of the transmission message is the voice and video detecting level, but the current session corresponding to the transmission message is not marked with the application label of text transmission function, then the detecting process is ended to maintain the detecting result of the text transmission detecting level.

It also needs to be noted that, to make the detection of the voice and video detecting level faster, as an alternative to detect traffic and Skype voice and video characteristics simultaneously at the level, the detection at the level can also be implemented by detecting only the traffic of the transmission message. That is, if the traffic statistical value of the third part of the transmission message is ascertained to be not less than the third preset statistical traffic threshold, the current session corresponding to the transmission message can be directly marked with the application label of voice and video function, which is not described in further details herein.

It can be seen from the descriptions above that the recognition method according to the embodiment of the invention is an incremental recognition method. When an application label of an upper level function is not marked, the current detection process is ended to maintain the detecting result of the upper level. In other words, the technical solutions according to the embodiment of the invention solve the problem of inability to distinguish coupled traffic during a Skype recognition process, and can precisely control a single function of Skype by using the incremental recognition method and the DPI and DFI combined detecting method.

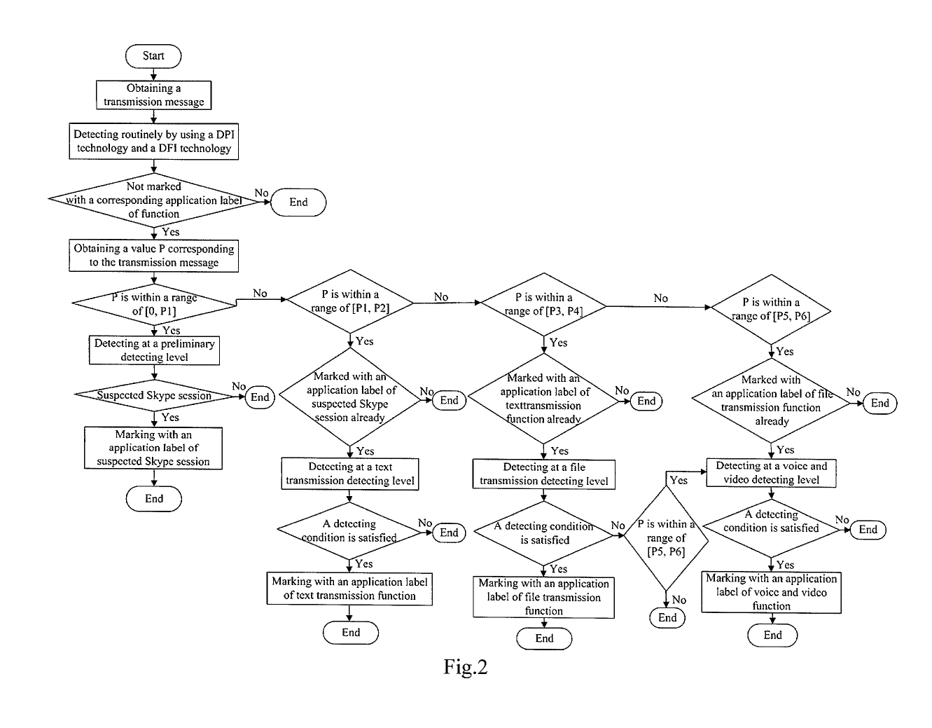

Moreover, to make the technical solutions of the embodiment of the invention clearer, a detailed flow of the recognition method based on communication streams of different functions of Skype according to the embodiment of the invention is illustrated by FIG. 2.

Moreover, after having recognized a single function of Skype according to the above mentioned flow, if it is needed to restrict traffic of the single function of Skype, the method further includes: restricting traffic of the current session marked with the corresponding application label of function.

Optionally, the traffic of the session marked with the corresponding application label of function can be restricted according to actual needs of a user. For example, in a work environment of a company, operations of sessions marked with the application label of voice and video function are restricted to improve network bandwidth of the work environment.

The first embodiment of the invention provides a recognition method based on communication streams of different functions of Skype, a transmission message in a current session is obtained and preliminarily detected. If the transmission message is accurately recognized, then the current session is marked with a corresponding application label of function. Otherwise a detecting level of the transmission message is determined and the transmission message is detected according to a detecting rule corresponding to the detecting level of the transmission message and the current session is marked with an application label of function corresponding to the detecting level of the transmission message if a detecting condition is satisfied. In other words, in the technical solution according to the embodiment of the invention, the problem of inability to distinguish between coupled traffic is solved through incremental recognition, so that a single function of Skype can be recognized and a precise access control of the traffic of Skype can be achieved, thus a specified function of Skype can be blocked and network bandwidth and a work environment can be improved.

### Second Embodiment

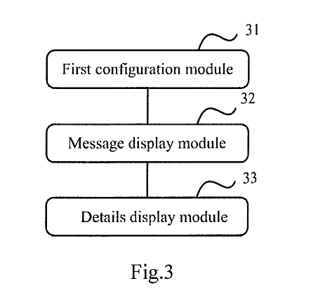

Based on a same inventive concept, the second embodiment of the invention provides a recognition apparatus based on communication streams of different functions of Skype. For particular implementations of the recognition apparatus, reference can be made to relevant descriptions of the first embodiment, which are not repeated herein. Particularly, as illustrated by FIG. 3, the recognition apparatus based on communication streams of different functions of Skype may include: an obtaining unit 31 configured to obtain a transmission message in a current session; an processing unit 32 configured to perform a preliminary detection of the transmission message obtained by the obtaining unit 31; and mark the current session with a corresponding application label of function if the transmission message is accurately recognized; or determine a detecting level of the transmission message if the transmission message is not accurately recognized, and detect the transmission message according to a detecting rule corresponding to the detecting level of the transmission message and mark the current session with an application label of function corresponding to the detecting level of the transmission message when a detecting condition is satisfied.

Moreover, the apparatus can further include a traffic restricting unit 33 configured to restrict traffic of the current session marked with the corresponding application label of function.

Moreover, the processing unit 32 is particularly configured to perform the preliminary detection of the transmission message by using a DPI technology and a DFI technology.

Moreover, the processing unit 32 is particularly configured to determine a value P corresponding to a position of the obtained transmission message in the current session and determine the detecting level of the transmission message according to the value P corresponding to the position of the transmission message in the current session and predefined detecting levels, wherein P is a positive integer.

Optionally, the detecting level at least includes a suspected Skype session detecting level, a text transmission detecting level, a file transmission detecting level and a voice and video detecting level.

Wherein a range of values corresponding to a position of a transmission message of the suspected Skype session detecting level in the current session is 0-P1, a range of values corresponding to a position of a transmission message of the text transmission detecting level in the current session is P1-P2, a range of values corresponding to a position of a transmission message of the file transmission detecting level in the current session is P3-P4, and a range of values corresponding to a position of a transmission message of the voice and video transmission detecting level in the current session is P5-P6, wherein 0<P1<P2, P2<P3<P4 and P2<P5<P6.

It should be noted that predefining a detecting level of Skype according to the number of transmission messages can be implemented through analysis of traffic characteristics of the transmission message and comprehensive processing of empirical values. And after having defined the detecting levels of Skype, a statistical threshold corresponding to traffic in each detecting level can be determined, i.e., a preset statistical traffic threshold corresponding to the suspected Skype session detecting level, a first preset statistical traffic threshold corresponding to the text transmission detecting level, a second preset statistical traffic threshold corresponding to the file transmission detecting level and a third preset statistical traffic threshold corresponding to the voice and video transmission detecting level. Moreover, It should be noted that generally traffic is not counted during suspected Skype session detecting, therefore the preset traffic statistical threshold corresponding to the suspected Skype session detecting level is usually zero, and the other preset traffic statistical thresholds are obtained through the analysis of traffic characteristics and comprehensive processing of empirical values, which is not repeated herein.

Moreover, the processing unit 32 is particularly configured to detect Skype characteristics of the transmission message upon determining that the detecting level of the transmission message is the suspected Skype session detecting level and that the current session is not marked with a corresponding application label of function.

Optionally, the Skype characteristics may include at least a session port, a message length, a flow direction of a message at a specific position, or a load of an application layer, which are not described in further details herein.

Moreover, the processing unit 32 is particularly configured to detect traffic and Skype text transmission characteristics of the transmission message upon determining that the detecting level of the transmission message is the text transmission level and the current session is marked with an application label of suspected Skype session.

Moreover, the processing unit 32 is particularly configured to detect the traffic and Skype file transmission characteristics of the transmission message upon determining that the detecting level of the transmission message is the file transmission detecting level and the current session corresponding to the transmission message is marked with an application label of text transmission function.

Moreover, the processing unit 32 is particularly configured to detect the traffic and Skype voice and video characteristics of the transmission message upon determining that the detecting level of the transmission message is the voice and video detecting level and the current session is marked with the application label of text transmission function.

The second embodiment of the invention provides a recognition apparatus based on communication streams of different functions of Skype, a transmission message in a current session is obtained and preliminarily detected. If the transmission message is accurately recognized, then the current session is marked with a corresponding application label of function. Otherwise a detecting level of the transmission message is determined and the transmission message is detected according to a detecting rule corresponding to the detecting level of the transmission message and the current session is marked with an application label of function corresponding to the detecting level of the transmission message if a detecting condition is satisfied. In other words, in the technical solution according to the embodiment of the invention, the problem of inability to distinguish between coupled traffic is solved through incremental recognition, so that a single function of Skype can be recognized and a precise access control of the traffic of Skype can be achieved, thus a specified function of Skype can be blocked and network bandwidth and a work environment can be improved.

Those skilled in the art shall appreciate that the embodiments of the invention can be embodied as a method, a device (system) or a computer program product. Therefore the invention can be embodied in the form of an all-hardware embodiment, an all-software embodiment or an embodiment of software and hardware in combination. Furthermore the invention can be embodied in the form of a computer program product embodied in one or more computer usable storage mediums (including but not limited to a disk memory, a CD-ROM and an optical memory) in which computer usable program codes are contained.

The invention has been described in a flow chart and/or a block diagram of the method, the apparatus (system) and the computer program product according to the embodiments of the invention. It shall be appreciated that respective flows and/or blocks in the flow chart and/or the block diagram and combinations of the flows and/or the blocks in the flow chart and/or the block diagram can be embodied by computer program instructions. These computer program instructions can be provided to a processor of a general-purpose computer, of a specific-purpose computer, of an embedded processing machine or of another programmable data processing device to produce a machine so that the instructions executed by the processor of computer or another programmable data processing device create means for performing the functions specified in the flow(s) of the flow chart and/or the block(s) of the block diagram.

These computer program instructions can also be stored into a computer readable memory capable of directing the computer or the other programmable data processing device to operate in a specific manner so that the instructions stored in the computer readable memory create an article of manufacture including instruction means which performs the functions specified in the flow(s) of the flow chart and/or the block(s) of the block diagram.

These computer program instructions can also be loaded onto the computer or the other programmable data processing device so that a series of operational operations are performed on the computer or the other programmable data processing device to create a computer implemented process so that the instructions executed on the computer or the other programmable device provide operations for performing the functions specified in the flow(s) of the flow chart and/or the block(s) of the block diagram.

Although preferred embodiments of the invention have been described, those skilled in the art can make other changes and modifications to these embodiments after knowing the basic inventive concept. Therefore, the appended claims are intended to include the preferred embodiments and all the changes and modifications falling into the scope of the invention.

Evidently those skilled in the art can make various modifications and variations to the invention without departing from the spirit and scope of the invention. Thus the invention is also intended to encompass these modifications and variations thereto so long as the modifications and variations come into the scope of the claims appended to the invention and their equivalents.

1. A recognition method based on communication streams of different functions of Skype, comprising:
obtaining a transmission message in a current session;
performing a preliminary detection of the transmission message, and marking the current session with a corresponding application label of function if the transmission message is accurately recognized; or
determining a detecting level of the transmission message if the transmission message is not accurately recognized; detecting the transmission message according to a detecting rule corresponding to the detecting level of the transmission message and marking the current session with an application label of function corresponding to the detecting level of the transmission message when a detecting condition is satisfied.

2. The method according to claim 1, further comprising:
restricting traffic of the current session marked with a corresponding application label of function.

3. The method according to claim 1, wherein performing the preliminary detection of the transmission message comprises:
performing the preliminary detection of the transmission message by using a Deep Packet Inspection (DPI) technology and a Deep/Dynamic Flow Inspection (DFI) technology.

4. The method according to claim 1, wherein determining the detecting level of the transmission message comprises:
determining a value P corresponding to a position of the obtained transmission message in the current session, wherein P is a positive integer; and
determining the detecting level of the transmission message according to the value P corresponding to the position of the transmission message in the current session and predefined detecting levels.

5. The method according to claim 1, wherein the detecting levels at least comprises a suspected Skype session detecting level, a text transmission detecting level, a file transmission detecting level and a voice and video detecting level;
wherein a range of values corresponding to a position of a transmission message of the suspected Skype session detecting level in the current session is 0-P1, a range of values corresponding to a position of a transmission message of the text transmission detecting level in the current session is P1-P2, a range of values corresponding to a position of a transmission message of the file transmission detecting level in the current session is P3-P4, and a range of values corresponding to a position of a transmission message of the voice and video transmission detecting level in the current session is P5-P6, wherein 0<P1<P2, P2<P3<P4 and P2<P5<P6.

6. The method according to claim 5, wherein upon determining that the detecting level of the transmission message is the suspected Skype session detecting level and the current session is not marked with a corresponding application label of function, detecting the transmission message according to the detecting rule corresponding to the detecting level of the transmission message comprises:
detecting Skype characteristics of the transmission message.

7. The method according to claim 6, wherein the Skype characteristics at least comprises:
a session port, a message length, a flow direction of a message at a specific position, or a load of an application layer.

8. The method according to claim 5, wherein upon determining that the detecting level of the transmission message is the text transmission level and the current session is marked with an application label of suspected Skype session, detecting the transmission message according to the detecting rule corresponding to the detecting level of the transmission message comprises:
detecting traffic and Skype text transmission characteristics of the transmission message.

9. The method according to claim 5, wherein upon determining that the detecting level of the transmission message is the file transmission detecting level and the current session corresponding to the transmission message is marked with an application label of text transmission function, detecting the transmission message according to the detecting rule corresponding to the detecting level of the transmission message comprises:
detecting traffic and Skype file transmission characteristics of the transmission message.

10. The method according to claim 5, wherein upon determining that the detecting level of the transmission message is the voice and video detecting level and the current session is marked with an application label of text transmission function, detecting the transmission message according to the detecting rule corresponding to the detecting level of the transmission message comprises:
detecting traffic and Skype voice and video characteristics of the transmission message.

11. A recognition apparatus based on communication streams of different functions of Skype, comprising:
at least one processor and a non-transitory memory, wherein the non-transitory memory is confirgure to store computer readable program codes and the at least one processor is configured to execute the computer readable program codes to,
obtain a transmission message in a current session;
perform a preliminary detection of the transmission message obtained by the obtaining unit; and
mark the current session with a corresponding application label of function if the transmission message is accurately recognized; or
determine a detecting level of the transmission message if the transmission message is not accurately recognized, detect the transmission message according to a detecting rule corresponding to the detecting level of the transmission message and mark the current session with an application label of function corresponding to the detecting level of the transmission message when a detecting condition is satisfied.

12. The apparatus according to claim 11, wherein the at least one processor is further configured to execute the computer readable program codes to restrict traffic of the current session marked with a corresponding application label of function.

13. The apparatus according to claim 11, the at least one processor is further configured to execute the computer readable program codes to perform the preliminary detection of the transmission message by using a Deep Packet Inspection (DPI) technology and a Deep/Dynamic Flow Inspection (DFI) technology.

14. The apparatus according to claim 11, wherein the at least one processor is further configured to execute the computer readable program codes to:
determine a value P corresponding to a position of the obtained transmission message in the current session, wherein P is a positive integer; and
determine the detecting level of the transmission message according to the value P corresponding to the position of the transmission message in the current session and predefined detecting levels.

15. The apparatus according to claim 11, wherein the detecting levels at least comprises a suspected Skype session detecting level, a text transmission detecting level, a file transmission detecting level and a voice and video detecting level;
wherein a range of values corresponding to a position of a transmission message of the suspected Skype session detecting level in the current session is 0-P1, a range of values corresponding to a position of a transmission message of the text transmission detecting level in the current session is P1-P2, a range of values corresponding to a position of a transmission message of the file transmission detecting level in the current session is P3-P4, and a range of values corresponding to a position of a transmission message of the voice and video transmission detecting level in the current session is P5-P6, wherein 0<P1<P2, P2<P3<P4 and P2<P5<P6.

16. The apparatus according to claim 15, wherein the at least one processor is further configured to execute the computer readable program to detect Skype characteristics of the transmission message upon determining that the detecting level of the transmission message is the suspected Skype session detecting level and the current session is not marked with a corresponding application label of function.

17. The apparatus according to claim 16, wherein the Skype characteristics at least comprises:
a session port, a message length, a flow direction of a message at a specific position, or a load of an application layer.

18. The apparatus according to claim 15, wherein the at least one processor is further configured to execute the computer readable program codes to detect traffic and Skype text transmission characteristics of the transmission message upon determining that the detecting level of the transmission message is the text transmission level and the current session is marked with an application label of suspected Skype session.

19. The apparatus according to claim 15, wherein the at least one processor is further configured to execute the computer readable program codes to detect traffic and Skype file transmission characteristics of the transmission message upon determining that the detecting level of the transmission message is the file transmission detecting level and the current session corresponding to the transmission message is marked with an application label of text transmission function.

20. The apparatus according to claim 15, wherein the at least one processor is further configured to execute the computer readable program codes to detect traffic and Skype voice and video characteristics of the transmission message upon determining that the detecting level of the transmission message is the voice and video detecting level and the current session is marked with an application label of text transmission function.
